(19) United States
(12) Patent Application Publication
(10) Pub. No.: US 2009/0153068 A1
(43) Pub. Date: Jun. 18, 2009

(54) BACKLIGHT ASSEMBLY, DISPLAY APPARATUS HAVING THE BACKLIGHT ASSEMBLY, AND METHOD THEREOF

(75) Inventors: Ju-Sung CHO, Gwangyang-si (KR); Moon-shik KANG, Seongnam-si (KR); Young-Sup KWON, Gwangmyeong-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/273,587

(22) Filed: Nov. 19, 2008

(30) Foreign Application Priority Data
Dec. 12, 2007 (KR) 10-2007-0129048

(51) Int. Cl. H05B 41/24; H05B 41/16

(52) U.S. Cl. 315/257; 315/250

(57) ABSTRACT

A backlight assembly includes a light-generating unit and an inverter. The light-generating unit includes a first U-shaped lamp and a second U-shaped lamp parallel with each other. Electrodes of the first and second U-shaped lamps are disposed at one side of the light-generating unit. The inverter includes a multi-output transformer, a first output terminal and a second output terminal. The multi-output transformer generates a first driving voltage and a second driving voltage having a phase opposite to a phase of the first driving voltage. The first and second output terminals electrically connect the first and second U-shaped lamps with the multi-output transformer. The multi-output transformer applies the first and second driving voltages to the first and second U-shaped lamps via the first and second output terminals.

This application claims priority to Korean Patent Application No. 2007-129048, filed on Dec. 12, 2007, and all the benefits accruing therefrom under 35 U.S.C. §119, the contents of which in its entirety are herein incorporated by reference.

### BACKGROUND OF THE INVENTION

1. Field of the Invention

Embodiments of the present invention relate to a backlight assembly, a display apparatus having the backlight assembly, and a method thereof. More particularly, embodiments of the present invention relate to a backlight assembly providing a display panel with light, a display apparatus having the backlight assembly, and a method thereof.

2. Description of the Related Art

Liquid crystal display (“LCD”) apparatuses are employed in monitors, notebook computers, cellular phones, large-screen televisions, etc., because the LCD apparatuses have thin thickness, light weight and low power consumption. An LCD apparatus includes a display panel and a backlight assembly. The display panel displays an image using light transmissivity of liquid crystal. The backlight assembly is disposed under the display panel and provides the display with light.

The backlight assembly includes lamps generating the light, an inverter providing the lamps with electric power and a receiving container receiving the lamps. The inverter generally raises an external voltage applied from an external device to provide the lamps with a high voltage. For example, the inverter includes at least one transformer raising the external voltage into the high voltage.

First electrodes of the lamps receive high voltages from the inverter and second electrodes of the lamps receive a ground voltage from the receiving container. The inverter should include a plurality of transformers providing the first electrodes of the lamps with the high voltages.

### BRIEF SUMMARY OF THE INVENTION

It has been determined herein, according to the present invention, that when an inverter of a backlight assembly includes a plurality of transformers, the manufacturing costs of the inverter increases.

Embodiments of the present invention provide a backlight assembly capable of decreasing the number of transformers to decrease manufacturing costs.

Embodiments of the present invention further provide a display apparatus having the backlight assembly.

Embodiments of the present invention further provide a method of decreasing costs of a backlight assembly.

According to one aspect of the present invention, there is provided a backlight assembly. The backlight assembly includes a light-generating unit and an inverter.

The light-generating unit includes a first U-shaped lamp and a second U-shaped lamp parallel with each other. Electrodes of the first and second U-shaped lamps are disposed at one side of the light-generating unit. The inverter includes a multi-output transformer, a first output terminal and a second output terminal. The multi-output transformer generates a first driving voltage and a second driving voltage having a phase opposite to a phase of the first driving voltage. The first and second output terminals electrically connect the first and second U-shaped lamps with the multi-output transformer. The multi-output transformer applies the first and second driving voltages to the first and second U-shaped lamps via the first and second output terminals.

The backlight assembly may further include a receiving container. The receiving container may include a bottom plate and sidewalls extending from ends of the bottom plate, and receive the light-generating unit.

In exemplary embodiments of the present invention, one of a first electrode and a second electrode of each of the first and second U-shaped lamps may be electrically connected to one of the first and second output terminals to receive one of the first and second driving voltages, and a remainder of the first and second electrodes of each of the first and second U-shaped lamps may be electrically connected to the receiving container to receive a ground voltage.

In other exemplary embodiments of the present invention, one of a first electrode and a second electrode of each of the first and second U-shaped lamps may be electrically connected to one of the first and second output terminals to receive one of the first and second driving voltages, and a remainder of the first and second electrode of each of the first and second U-shaped lamps may be electrically connected to a remainder of the first and second output terminal to receive a remainder of the first and second driving voltages.

In still other exemplary embodiments of the present invention, the backlight assembly may further include a connection unit electrically connecting the first and second output terminals with electrodes of the first and second U-shaped lamps. The connection unit may include at least one connector. The connector may have a first end electrically connected to one of the first and second output terminals and a second end electrically connected to at least two electrodes of the first and second U-shaped lamps.

In yet other exemplary embodiments of the present invention, the backlight assembly may further include a connection socket. The connection socket may be received in the receiving container and electrically connected to the electrodes of the first and second U-shaped lamps.

According to another aspect of the present invention, there is provided a backlight assembly. The backlight assembly includes a light-generating unit and an inverter.

The light-generating unit includes a first U-shaped lamp and a second U-shaped lamp parallel with each other. Electrodes of the first and second U-shaped lamps may be disposed at one side of the light-generating unit. The inverter includes a multi-output transformer. The multi-output transformer generates a first driving voltage which is applied to the first U-shaped lamp via a first output terminal of the inverter and a second driving voltage which is applied to the second U-shaped lamp via a second output terminal of the inverter. The second driving voltage may have a phase substantially opposite to a phase of the first driving voltage.

The backlight assembly may further include a receiving container. The receiving container includes a bottom plate and sidewalls extending from ends of the bottom plate and receives the light-generating unit.

In exemplary embodiments of the present invention, one of a first electrode and a second electrode of the first U-shaped lamp may be electrically connected to the first output terminal to receive the first driving voltage and a remainder of the first and second electrodes of the first U-shaped lamp may be electrically connected to the receiving container to receive a ground voltage.

Additionally, one of a first electrode and a second electrode of the second U-shaped lamp may be electrically connected to the second output terminal to receive the second driving voltage, and a remainder of the first and second electrodes of the second U-shaped lamp may be electrically connected to the receiving container to receive the ground voltage.

According to yet another aspect of the present invention, there is provided a display apparatus. The display apparatus includes a backlight assembly generating light and a display panel displaying an image using the light.

The backlight assembly may include a light-generating unit and an inverter. The light-generating unit may include a first U-shaped lamp and a second U-shaped lamp parallel with each other. Electrodes of the first and second U-shaped lamps may be disposed at one side of the light-generating unit. The inverter may include a multi-output transformer. The multi-output transformer may generate a first driving voltage and a second driving voltage. The first driving voltage may be applied to the first U-shaped lamp via a first output terminal of the inverter and the second driving voltage may be applied to the second U-shaped lamp via a second output terminal of the inverter. The second driving voltage may have a phase substantially opposite to a phase of the first driving voltage.

According to still yet another aspect of the present invention, a method of decreasing manufacturing costs of a backlight assembly includes arranging first and second U-shaped lamps parallel to each other, electrodes of the first and second U-shaped lamps disposed at one side, electrically connecting an inverter to at least one electrode of each of the first and second U-shaped lamps, reducing a number of transformers within the backlight assembly by disposing a multi-output transformer on the inverter, the multi-output transformer generating at least a first driving voltage and a second driving voltage, providing the first driving voltage to the first U-shaped lamp from a first output terminal of the inverter, and providing the second driving voltage to the second U-shaped lamp from a second output terminal of the inverter.

According to exemplary embodiments of the present invention, a multi-output transformer is electrically connected to at least two U-shaped lamps to drive the two U-shaped lamps. Therefore, the number of the transformers may be decreased so that the manufacturing costs of the inverter may decrease.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a cross-sectional view illustrating an exemplary display apparatus in accordance with exemplary embodiments of the present invention;

FIG. 2 is a plan view conceptually illustrating an exemplary backlight assembly illustrated in FIG. 1;

FIG. 3 is a block diagram illustrating an exemplary inverter illustrated in FIG. 2;

FIG. 4 is a plan view conceptually illustrating an exemplary backlight assembly in accordance with exemplary embodiments of the present invention;

FIG. 5 is a cross-sectional view taken along line I-I′ shown in FIG. 4;

FIG. 6 is a cross-sectional view taken along line II-II′ shown in FIG. 4;

FIG. 7 is a plan view illustrating an exemplary backlight assembly in accordance with exemplary embodiments of the present invention;

FIG. 8 is a plan view illustrating an exemplary backlight assembly in accordance with exemplary embodiments of the present invention; and

FIG. 9 is a plan view illustrating an exemplary backlight assembly in accordance with exemplary embodiments of the present invention.

### DETAILED DESCRIPTION OF THE INVENTION

The present invention is described more fully hereinafter with reference to the accompanying drawings, in which embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

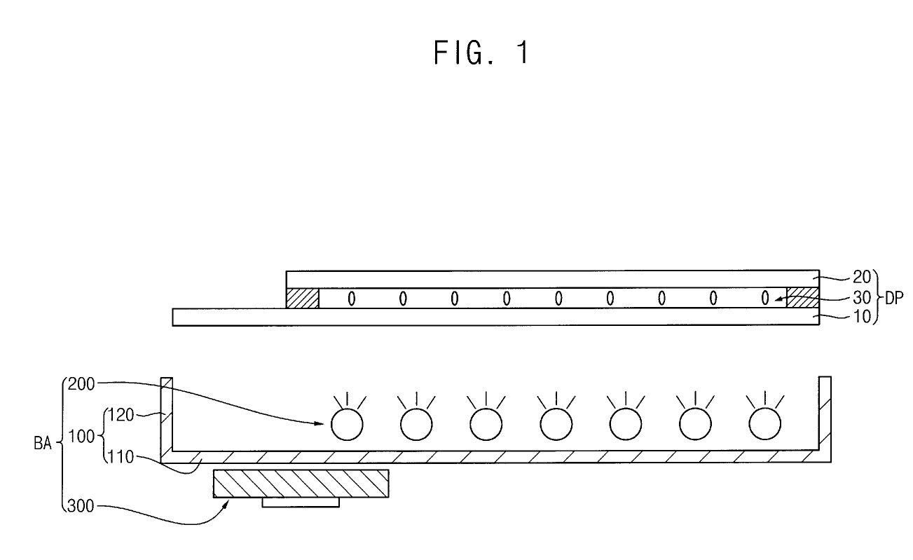

FIG. 1 is a cross-sectional view illustrating an exemplary display apparatus in accordance with exemplary embodiments of the present invention.

Referring to FIG. 1, a display apparatus includes a display panel DP displaying an image and a backlight assembly BA providing the display panel DP with light.

In exemplary embodiments of the present invention, the display panel DP may include a liquid crystal display (“LCD”) panel. For example, the display panel DP may include a first substrate 10, a second substrate 20 opposite to the first substrate 10 and a liquid crystal layer 30 disposed between the first substrate 10 and the second substrate 20.

Although not illustrated, the first substrate 10 may include a plurality of gate lines, a plurality of data lines, a plurality of thin-film transistors (“TFTs”), and a plurality of pixel electrodes. The gate lines may extend in a first direction. The data lines may extend in a second direction different from the first direction, such as perpendicular to the first direction. The TFTs may be electrically connected to the gate lines and the data lines. The pixel electrodes may be electrically connected to the TFTs and include a transparent conductive material.

The second substrate 20 may be opposite to the first substrate 10. Although not illustrated, the second substrate 20 may include a plurality of color filters and a common electrode. The color filters may correspond to the pixel electrodes. The common electrode may be formed on the entire surface or substantially the entire surface of the second substrate and include a transparent conductive material. For example, the color filters may include a red color filter, a green color filter and a blue color filter.

The liquid crystal layer 30 may be disposed between the first substrate 10 and the second substrate 20. The liquid crystal layer 30 may include liquid crystal of which an arrangement may be changed by an electric field formed between the first substrate 10 and the second substrate 20. Because an amount of light passing through the liquid crystal layer 30 may be changed by the arrangement of the liquid crystal, the display panel DP may display the image.

While an LCD panel has been described as the display panel DP, the present invention is not limited to an LCD panel and may include other display panels that utilize backlight assemblies.

The backlight assembly BA may be disposed under the display panel DP. The backlight assembly BA provides the display panel DP with light.

Although not illustrated, the display apparatus may further include an optical member increasing optical properties of the light generated from the backlight assembly BA. The optical member may be disposed between the display panel DP and the backlight assembly BA.

For example, the optical member may include a diffusing plate and a prism sheet. The diffusing plate may diffuse the light generated from the backlight assembly BA. The prism sheet may concentrate the light passing through the diffusing plate so that front brightness of the display panel may be increased. Alternative arrangements of optical sheets may also be included in the optical member.

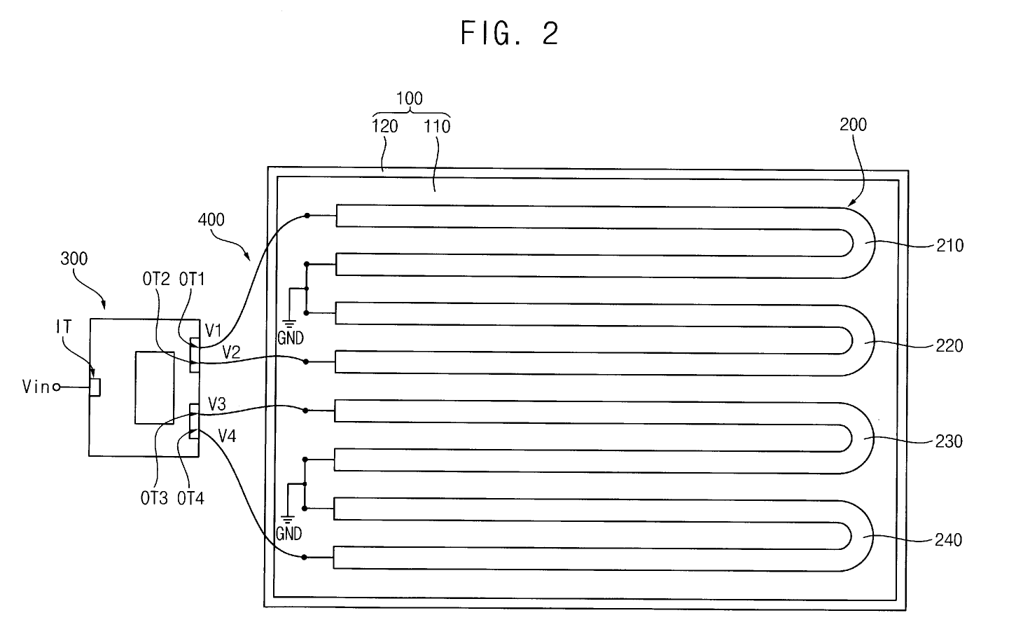

FIG. 2 is a plan view conceptually illustrating an exemplary backlight assembly illustrated in FIG. 1.

Referring to FIGS. 1 and 2, the backlight assembly BA may include a receiving container 100, a light-generating unit 200, an inverter 300 and a connection unit 400.

The receiving container 100 may include a bottom plate 110 and sidewalls 120 extending from edges of the bottom plate 110. The receiving container 100 receives the light-generating unit 200.

The light-generating unit 200 may include a plurality of U-shaped lamps 210, 220, 230, and 240. The U-shaped lamps 210, 220, 230, and 240 are received in the receiving container 100. In exemplary embodiments of the present invention, each of the U-shaped lamps 210, 220, 230, and 240 includes a curved portion, two straight portions extended from edges of the curved portion, and two electrodes formed at end portions of the two straight portions. The straight portions of the U-shaped lamps 210, 220, 230, and 240 may be substantially parallel with one another and the electrodes of the U-shaped lamps 210, 220, 230, and 240 may be disposed on one side of the receiving container 100.

In exemplary embodiments of the present invention, the light-generating unit 200 may include a first U-shaped lamp 210, a second U-shaped lamp 220, a third U-shaped lamp 230, and a fourth U-shaped lamp 240 parallel disposed in a direction. Electrodes of the first to fourth lamps 210, 220, 230, and 240 may be disposed adjacent to one of the sidewalls 120. While four lamps 210, 220, 230, and 240 are described, it should be understood that alternative exemplary embodiments of a backlight assembly BA may include more or less than four lamps, according to a size of the display panel DP.

The inverter 300 receives an external direct current (“DC”) voltage Vin from an external device. The inverter 300 may change the external DC voltage Vin into a plurality of driving voltages for driving the U-shaped lamps 210, 220, 230, and 240. For example, the inverter 300 may output a first driving voltage V1, a second driving voltage V2, a third driving voltage V3, and a fourth driving voltage V4 for driving the first to fourth U-shaped lamps 210, 220, 230, and 240 via a first output terminal OT1, a second output terminal OT2, a third output terminal OT3, and a fourth output terminal OT4.

In an exemplary embodiment of the present invention, the second driving voltage V2 may be an alternating current (“AC”) voltage having a phase that is opposite to a phase of the first driving voltage V1, and the fourth driving voltage V4 may be an AC voltage having a phase that is opposite to a phase of the third driving voltage V3. Additionally, the third driving voltage V3 may be an AC voltage that is substantially the same as the first driving voltage V1, and the fourth driving voltage V4 may be an AC voltage that is substantially the same as the second driving voltage V2.

In an exemplary embodiment of the present invention, the inverter 300 may be disposed on a rear surface of the bottom plate 110. In another exemplary embodiment of the present invention, the inverter 300 may be disposed on an external surface of one of the sidewalls 120 that corresponds to the electrodes of the U-shaped lamps 210, 220, 230, and 240.

The connection unit 400 may electrically connect the inverter 300 with the U-shaped lamps 210, 220, 230, and 240. For example, the connection unit 400 may electrically connect the first to fourth output terminals OT1, OT2, OT3, and OT4 with some of the electrodes of the four U-shaped lamps 210, 220, 230, and 240.

A first electrode of the first U-shaped lamp 210 may be electrically connected to the first output terminal OT1 via the connection unit 400 to receive the first driving voltage V1 outputted from the first output terminal OT1.

A second electrode of the first U-shaped lamp 210 is adjacent to the first electrode of the first U-shaped lamp 210. The second electrode of the first U-shaped lamp 210 may be electrically connected to the receiving container 100 to receive a ground voltage from the receiving container 100.

A first electrode of the second U-shaped lamp 220 is adjacent to the second electrode of the first U-shaped lamp 210. The first electrode of the second U-shaped lamp 220 may be electrically connected to the second electrode of the first U-shaped lamp to receive the ground voltage from the receiving container 100.

A second electrode of the second U-shaped lamp 220 is adjacent to the first electrode of the second U-shaped lamp 220. The second electrode of the second U-shaped lamp 220 may be electrically connected to the second output terminal OT2 via the connection unit 400 to receive the second driving voltage V2 outputted from the second output terminal OT2.

A first electrode of the third U-shaped lamp 230 may be electrically connected to the third output terminal OT3 via the connection unit 400 to receive the third driving voltage V3 outputted from the third output terminal OT3.

A second electrode of the third U-shaped lamp 230 is adjacent to the first electrode of the third U-shaped lamp 230. The second electrode of the third U-shaped lamp 230 may be electrically connected to the receiving container 100 to receive the ground voltage from the receiving container 100.

A first electrode of the fourth U-shaped lamp 240 is adjacent to the second electrode of the third U-shaped lamp 230. The first electrode of the fourth U-shaped lamp 240 may be electrically connected to the second electrode of the third U-shaped lamp 230 to receive the ground voltage from the receiving container 100.

A second electrode of the fourth U-shaped lamp 240 is adjacent to the first electrode of the fourth U-shaped lamp 240. The second electrode of the fourth U-shaped lamp 240 may be electrically connected to the fourth output terminal OT4 via the connection unit 400 to receive the fourth driving voltage V4 outputted from the fourth output terminal OT4.

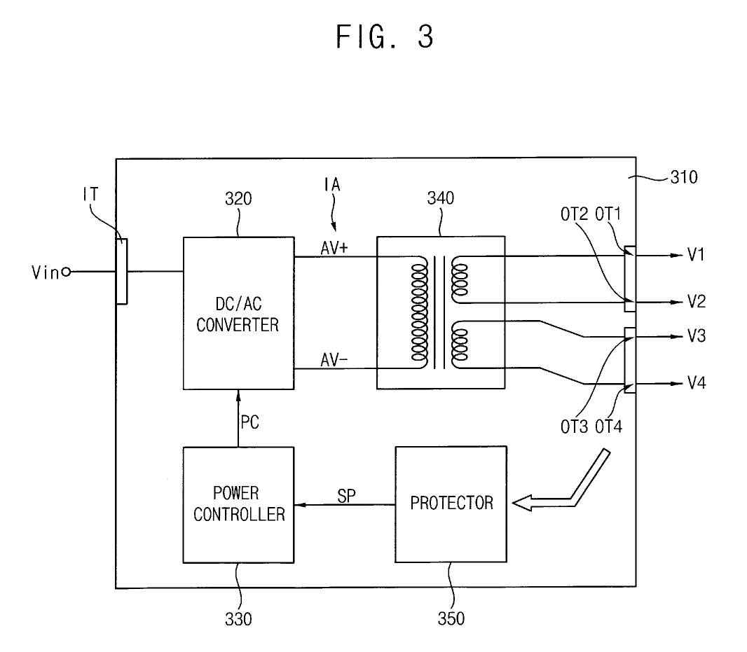

FIG. 3 is a block diagram illustrating an exemplary inverter illustrated in FIG. 2.

Referring to FIGS. 2 and 3, the inverter 300 may include an inverter substrate 310, a DC/AC converter 320, a power controller 330, a multi-output transformer 340, and a protector 350.

For example, the inverter substrate 310 may include a printed circuit board (“PCB”). Electrical patterns may be formed on one surface of the PCB or two surfaces of the PCB.

The DC/AC converter 320 may be disposed on the inverter substrate 310. The DC/AC converter 320 may receive the external DC voltage Vin from an input terminal IT formed on the inverter substrate 310. For example, the external DC voltage Vin may be about 24 V. The DC/AC converter 320 may convert the external DC voltage Vin into an internal output AC voltage IA to output to the multi-output transformer 340.

The power controller 330 may be disposed on the inverter substrate 310. The power controller 330 may output a power controlling signal PC to the DC/AC converter 320. The power controller 330 may control the internal output AC voltage IA outputted from the DC/AC converter 320. For example, the power controller 330 may control an output, a level, a frequency, etc. of the internal output AC voltage IA.

The multi-output transformer 340 may receive the internal output AC voltage IA from the DC/AC converter 320 and convert the internal output AC voltage IA into driving voltages for driving the U-shaped lamps 210, 220, 230, and 240.

The multi-output transformer 340 may include a four-output transformer outputting the first driving voltage V1, the second driving voltage V2, the third driving voltage V3, and the fourth driving voltage V4. For example, the multi-output transformer 340 may include an input coil receiving the internal output AC voltage IA, a first output coil outputting the first and second driving voltages V1 and V2, and a second output coil outputting the third and fourth driving voltages V3 and V4.

In exemplary embodiments of the present invention, a first AC voltage AV+ and a second AC voltage AV− of the internal output AC voltage IA are respectively applied to the ends of the input coil in the multi-output transformer 340. The first and second AC voltage AV+ and AV− are AC voltages which have phases opposite to each other.

Both ends of the first output coil may be electrically connected to the first and second output terminals OT1 and OT2, respectively, and both ends of the second output coil may be electrically connected to the third and fourth output terminals OT3 and OT4, respectively.

The multi-output transformer 340 may raise the internal output AC voltage IA applied to the input coil to output the first to fourth driving voltages V1, V2, V3, and V4 through the ends of the first and second output coils. For example, the first to fourth driving voltages V1, V2, V3, and V4 maybe AC voltages having amplitudes of about 1 kV to about 10 kV.

The protector 350 may detect irregularities of the driving voltages V1, V2, V3, and V4 applied to the U-shaped lamps 210, 220, 230, and 240 through the output terminals OT1, OT2, OT3, and OT4 of the inverter 300 and control output of the driving voltages V1, V2, V3, and V4 from the multi-output transformer 340.

For example, the protector 350 may directly or indirectly sense a first induced voltage, a second induced voltage, a third induced voltage, and a fourth induced voltage, which respectively correspond to the first driving voltage V1, the second driving voltage V2, the third driving voltage V3, and the fourth driving voltage V4, from the first output terminal OT1, the second output terminal OT2, the third output terminal OT3, and the fourth output terminal OT4, respectively.

The protector 350 may compare the first to fourth induced voltages with reference voltages to output a protection signal SP to the power controller 330. The power controller 330 may control the DC/AC converter 320 to control the output of the first to fourth driving voltages V1, V2, V3, and V4 from the multi-output transformer 340 in response to the protection signal SP.

When the backlight assembly BA has problems, such as when the U-shaped lamps 210, 220, 230, 240 are damaged, or when the output terminals OT1, OT2, OT3, OT4 of the inverter 300 are electrically shorted or broken, etc., the inverter 300 may excessively apply the driving voltages V1, V2, V3, V4 to some of the U-shaped lamps 210, 220, 230, 240. When the driving voltages V1, V2, V3, V4 are excessively larger than reference driving voltages suitable for driving the U-shaped lamps 210, 220, 230, 240, the protector 350 may temporarily or permanently prevent the driving voltages V1, V2, V3, V4 excessively larger than the reference driving voltages from being outputted from the multi-output transformer 340.

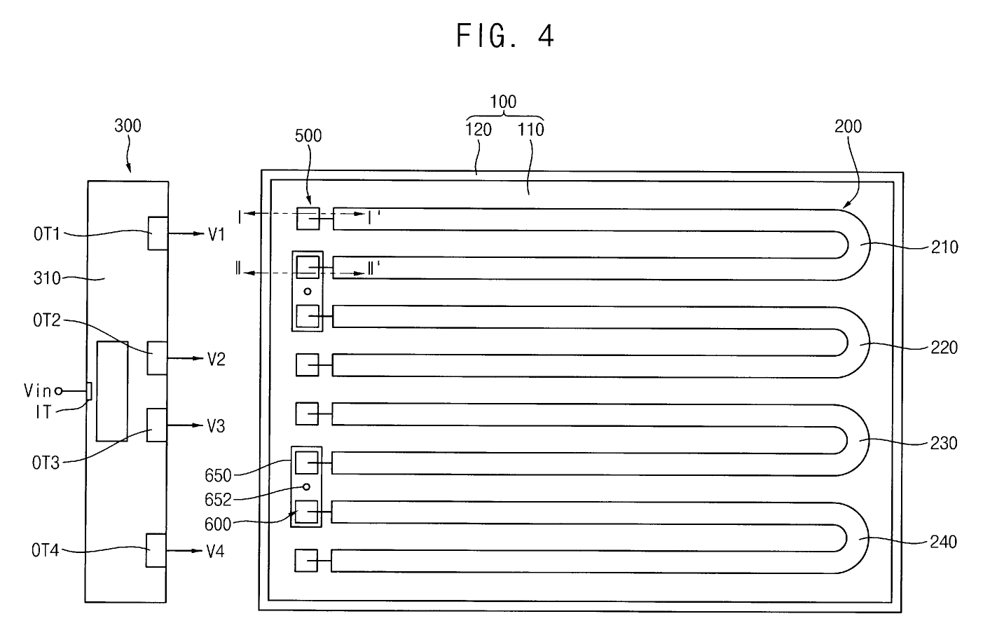

FIG. 4 is a plan view conceptually illustrating an exemplary backlight assembly in accordance with exemplary embodiments of the present invention. While the exemplary backlight assembly illustrated in FIG. 4 includes four U-shaped lamps 210, 220, 230, 240 received within the receiving container 100, and four output terminals OT1, OT2, OT3, OT4 in the inverter 300, an alternate quantity of lamps and corresponding output terminals may be provided within the backlight assembly.

Referring to FIGS. 2 and 4, the backlight assembly may further include a connection socket electrically connecting the inverter 300 with the U-shaped lamps 210, 220, 230, 240. The connection socket may replace the connection unit 400. The connection socket is received in the receiving container 100. The connection socket may be electrically connected to the electrodes of the U-shaped lamps 210, 220, 230, 240 and apply the driving voltages V1, V2, V3, V4 and the ground voltage to the electrodes of the U-shaped lamps 210, 220, 230, 240.

The connection socket may include driving voltage applying sockets 500 and ground voltage applying sockets 600.

Each of the driving voltage applying sockets 500 is electrically connected to one of the first and second electrodes of each of the U-shaped lamps 210, 220, 230, 240, and each of the ground voltage applying sockets 600 is electrically connected to the other of the first and second electrodes of each of the U-shaped lamps 210, 220, 230, 240. The driving voltage applying sockets 500 apply the driving voltages V1, V2, V3, V4 to the U-shaped lamps 210, 220, 230, 240, and the ground voltage applying sockets 600 apply the ground voltage to the U-shaped lamps 210, 220, 230, 240.

For example, the driving voltage applying sockets 500 may be electrically connected to the first to fourth output terminals OT1, OT2, OT3, and OT4 to receive the first to fourth driving voltages V1, V2, V3, and V4, respectively. In addition, the driving voltage applying sockets 500 may be electrically connected to the first electrode of the first U-shaped lamp 210, the second electrode of the second U-shaped lamp 220, the first electrode of the third U-shaped lamp 230, and the second electrode of the fourth U-shaped lamp 240, respectively, to apply the first to fourth driving voltages V1, V2, V3, and V4 to the first electrode of the first U-shaped lamp 210, the second electrode of the second U-shaped lamp 220, the first electrode of the third U-shaped lamp 230, and the second electrode of the fourth U-shaped lamp 240, respectively.

The ground voltage applying sockets 600 may be electrically connected to the bottom plate 110 of the receiving container 100 to receive the ground voltage from the receiving container 100. In addition, the ground voltage applying sockets 600 may be electrically connected to the second electrode of the first U-shaped lamp 210, the first electrode of the second U-shaped lamp 220, the second electrode of the third U-shaped lamp 230, and the first electrode of the fourth U-shaped lamp 240, respectively, to apply the ground voltage to the second electrode of the first U-shaped lamp 210, the first electrode of the second U-shaped lamp 220, the second electrode of the third U-shaped lamp 230, and the first electrode of the fourth U-shaped lamp 240, respectively.

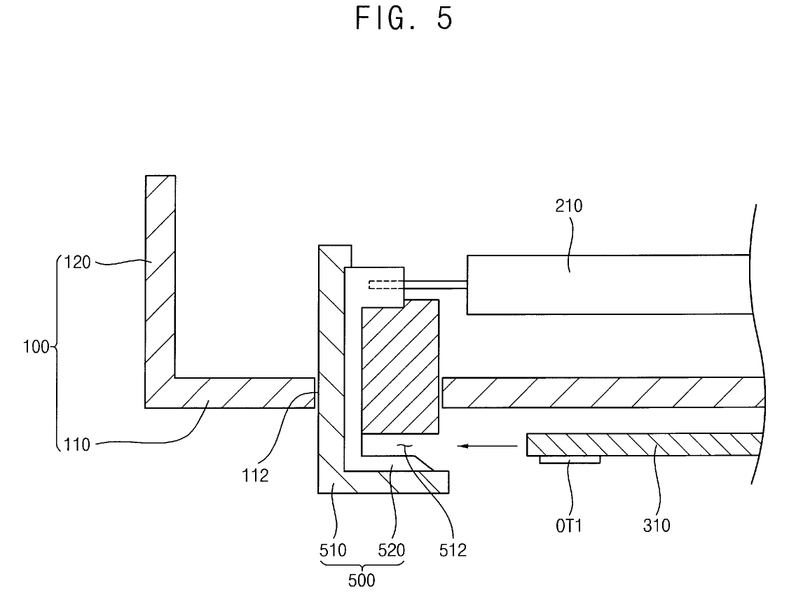

FIG. 5 is a cross-sectional view taken along line I-I′ shown in FIG. 4, and illustrates a cross-section of an exemplary driving voltage applying socket 500 in relation to the receiving container 100, the lamp 210, and the inverter substrate 310.

Referring to FIGS. 4 and 5, the driving voltage applying sockets 500 may be received in the receiving container 100. In addition, the bottom plate 110 of the receiving container 100 may have a socket through-hole 112 through which a portion of each driving voltage applying socket 500 passes to protrude from a rear surface of the bottom plate 110 of the receiving container 100. In other words, a portion of each driving voltage applying socket 500 is accessible on one side of the bottom plate 110, such as above the bottom plate 110, and another portion of each driving voltage applying socket 500 is accessible on an opposite side of the bottom plate 110, such as below the bottom plate 110.

Each of the driving voltage applying sockets 500 may include a driving socket body 510 and a driving voltage applier 520.

For example, the driving socket body 510 may be received in the receiving container 100 to correspond to the first electrode of the first U-shaped lamp 210 and pass through the socket through-hole 112 to protrude from the rear surface of the bottom plate 110. A portion of the driving socket body 510 protruding from the rear surface of the bottom plate 110 may have an insertion recess 512 into which a portion of the inverter substrate 310 is inserted. For example, the portion of the inverter substrate 310 may slide into the insertion recess 512 to be combined with the driving socket body 510. The first output terminal OT1 provided on or within the inverter substrate 310 is disposed on or within the portion of the inverter substrate 310 that is inserted into the insertion recess 512.

The driving voltage applier 520 may be disposed in the driving socket body 510. For example, the driving voltage applier 520 may be electrically connected to the first output terminal OT1 of the inverter 300 and the first electrode of the first U-shaped lamp 210. The first electrode of the first U-shaped lamp 210 may be combined with an upper portion of the driving voltage applier 520 to be electrically connected to the upper portion of the driving voltage applier 520. A portion of the driving socket body 510 and driving voltage applier 520 protruding above the bottom plate 110 may provide a connection for receiving and electrically connecting the first electrode of the first U-shaped lamp 210 thereto. In addition, the first output terminal OT1 of the inverter 300 may be electrically connected to a lower portion of the driving voltage applier 520 when the inverter substrate 310 is inserted into the insertion recess 512 to combine with the driving socket body 510.

The first to fourth output terminals OT1, OT2, OT3, and OT4 may include metal patterns which are formed on the inverter substrate 310 and electrically connected to the driving voltage appliers 520, respectively.

The inverter substrate 310 may have a shape extending in a first direction to combine with the driving voltage applying sockets 500 arranged in the first direction. A length of the inverter substrate 310 may be substantially the same as or smaller than a length of one sidewall 120 facing the inverter 300.

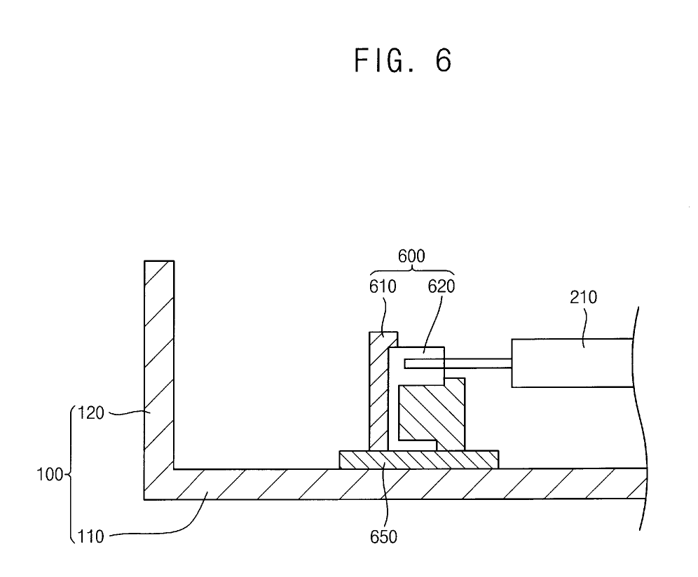

FIG. 6 is a cross-sectional view taken along line II-II′ shown in FIG. 4.

Referring to FIGS. 4 and 6, each of the ground voltage applying sockets 600 may include a ground socket body 610 and a ground voltage applier 620.

For example, the ground socket body 610 may be disposed in the receiving container 100 and above an inner surface of the bottom plate 110 to correspond to the second electrode of the first U-shaped lamp 210.

The ground voltage applier 620 may be disposed in the ground socket body 610 and electrically connected to the bottom plate 110 of the receiving container 100. For example, an upper portion of the ground voltage applier 620 may combine with the second electrode of the first U-shaped lamp 210 so that the ground voltage applier 620 may be electrically connected to the second electrode of the first U-shaped lamp 210.

The backlight assembly may further include a metal connection plate 650 disposed between the ground socket body 610 and the bottom plate 110 of the receiving container 100.

The metal connection plate 650 may be electrically connected to the bottom plate 110 and the ground voltage applier 620. The metal connection plate 650 may be electrically connected to the bottom plate 110 through a screw fixing the connection plate 650 to the bottom plate 110. The metal connection plate 650 may transfer the ground voltage from the receiving container 100 to the ground voltage applier 620.

The metal connection plate 650 may extend in a direction to overlap with two ground voltage applying sockets 600 adjacent to each other, so that the metal connection plate 650 may be electrically connected to the two adjacent ground voltage applying sockets 600.

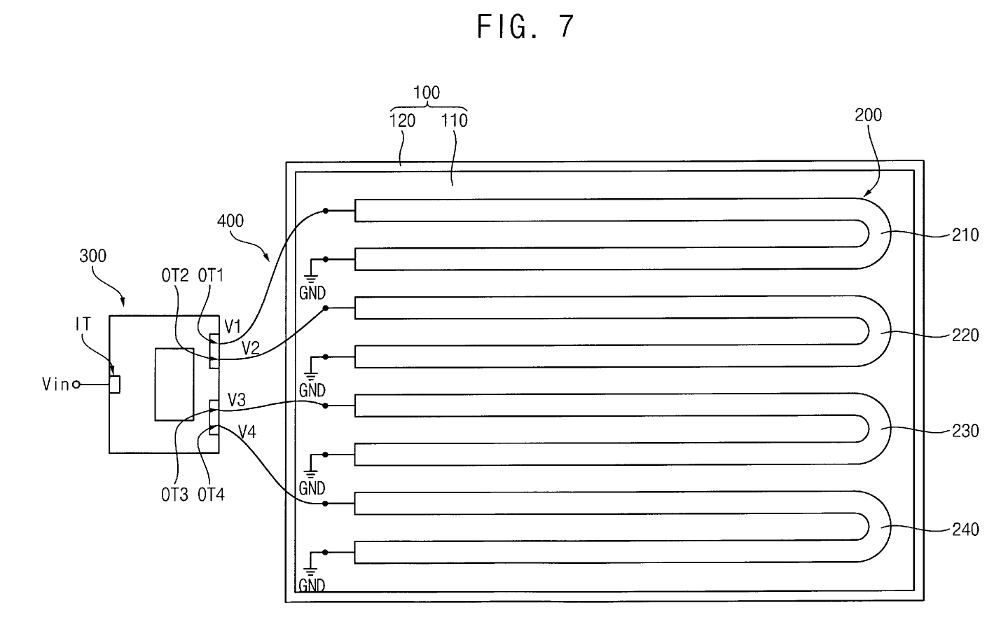

FIG. 7 is a plan view illustrating an exemplary backlight assembly in accordance with exemplary embodiments of the present invention. A backlight assembly illustrated in FIG. 7 has a structure substantially the same as that of the backlight assembly illustrated in FIG. 2 except for a connection between the inverter 300 and the receiving container 100. Thus, any repetitive explanation will be omitted.

Referring to FIGS. 2 and 7, the first electrode of the first U-shaped lamp 210 is electrically connected to the first output terminal OT1 of the inverter 300 by the connection unit 400 to receive the first driving voltage V1 from the first output terminal OT1. The second electrode of the first U-shaped lamp 210 is electrically connected to the receiving container 100 to receive the ground voltage from the receiving container 100.

The first electrode of the second U-shaped lamp 220 is electrically connected to the second output terminal OT2 of the inverter 300 by the connection unit 400 to receive the second driving voltage V2 from the second output terminal OT2 of the inverter 300. The second electrode of the second U-shaped lamp 220 is electrically connected to the receiving container 100 to receive the ground voltage from the receiving container 100.

The first electrode of the third U-shaped lamp 230 is electrically connected to the third output terminal OT3 of the inverter 300 by the connection unit 400 to receive the third driving voltage V3 from the third output terminal OT3 of the inverter 300. The second electrode of the third U-shaped lamp 230 is electrically connected to the receiving container 100 to receive the ground voltage from the receiving container 100.

The first electrode of the fourth U-shaped lamp 240 is electrically connected to the fourth output terminal OT4 of the inverter 300 by the connection unit 400 to receive the fourth driving voltage V4 from the fourth output terminal OT4 of the inverter 300. The second electrode of the fourth U-shaped lamp 240 is electrically connected to the receiving container 100 to receive the ground voltage from the receiving container 100.

In embodiments of the present invention, the first electrodes of the first, second, third, and fourth U-shaped lamps 210, 220, 230, and 240 may be electrically connected to the first, second, third, and fourth output terminals OT1, OT2, OT3, and OT4 of the inverter 300 by the driving voltage applying sockets 500 illustrated in FIG. 4, respectively.

Additionally, the second electrodes of the first, second, third, and fourth U-shaped electrodes 210, 220, 230, and 240 may be electrically connected to the receiving container 100 by the ground voltage applying sockets 600 illustrated in FIG. 4.

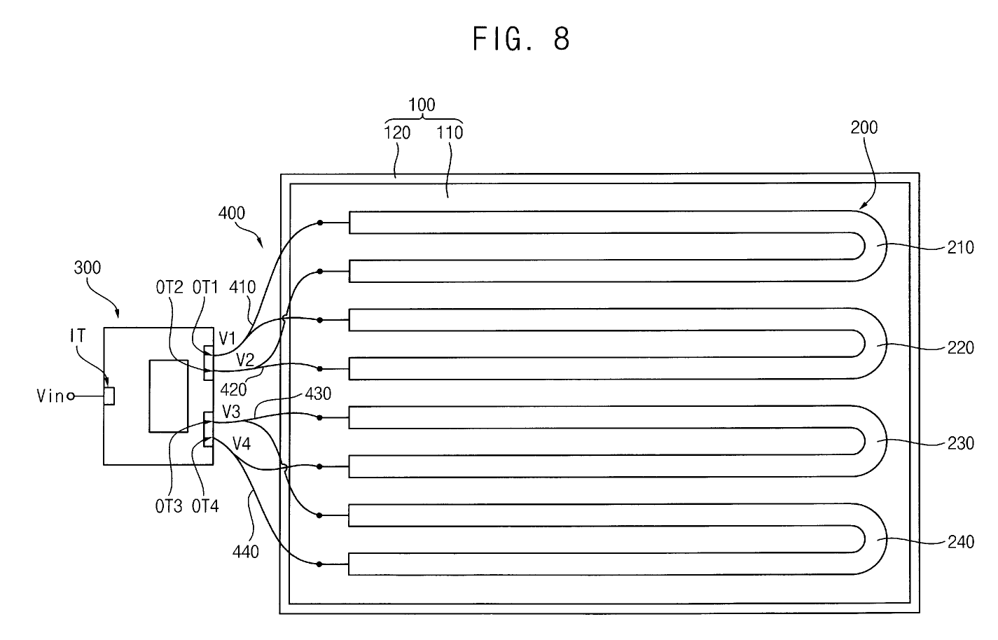

FIG. 8 is a plan view illustrating an exemplary backlight assembly in accordance with exemplary embodiments of the present invention. The backlight assembly illustrated in FIG. 8 has a structure substantially the same as that of the backlight assembly illustrated in FIG. 2 except for an electrical connection between the U-shaped lamps 210, 220, 230, 240 and the inverter 300. Thus, any repetitive explanation will be omitted.

Referring to FIGS. 2 and 8, the connection unit 400 includes at least one connector having a first end electrically connected to one of the output terminals of the inverter 300 and a second end electrically connected to at least two of the electrodes of the U-shaped lamps. For example, the connection unit 400 may include a first connector 410, a second connector 420, a third connector 430, and a fourth connector 440.

The first electrode of the first U-shaped lamp 210 is electrically connected to the first output terminal OT1 of the inverter 300 by the first connector 410 to receive the first driving voltage V1 from the first output terminal OT1 of the inverter 300. The second electrode of the first U-shaped lamp 210 is electrically connected to the second output terminal OT2 of the inverter 300 by the second connector 420 to receive the second driving voltage V2 from the second output terminal OT2 of the inverter 300.

The first electrode of the second U-shaped lamp 220 is electrically connected to the first output terminal OT1 of the inverter 300 by the first connector 410 to receive the first driving voltage V1 from the first output terminal OT1 of the inverter 300. The second electrode of the second U-shaped lamp 220 is electrically connected to the second output terminal OT2 by the second connector 420 to receive the second driving voltage V2 from the second output terminal OT2 of the inverter 300.

The first electrode of the third U-shaped lamp 230 is electrically connected to the third output terminal OT3 of the inverter 300 by the third connector 430 to receive the third driving voltage V3 from the third output terminal OT3 of the inverter. The second electrode of the third U-shaped lamp 230 is electrically connected to the fourth output terminal OT4 by the fourth connector 440 to receive the fourth driving voltage V4 from the fourth output terminal OT4 of the inverter 300.

The first electrode of the fourth U-shaped lamp 240 is electrically connected to the third output terminal OT3 of the inverter 300 by the third connector 430 to receive the third driving voltage V3 from the third output terminal OT3 of the inverter 300. The second electrode of the fourth U-shaped lamp 240 is electrically connected to the fourth output terminal OT4 of the inverter 300 by the fourth connector 440 to receive the fourth driving voltage V4 from the fourth output terminal OT4 of the inverter 300.

In the embodiments of the present invention, electric power of the inverter of which one output terminal is electrically connected to two electrodes may be about double as that of which one output terminal is electrically connected to one electrode.

In embodiments of the present invention, the electrodes of the first, second, third and fourth U-shaped lamps 210, 220, 230, and 240 may be electrically connected to first, second, third, and fourth output terminals OT1, OT2, OT3, and OT4 of the inverter 300 by the driving voltage applying sockets 500 illustrated in FIG. 4.

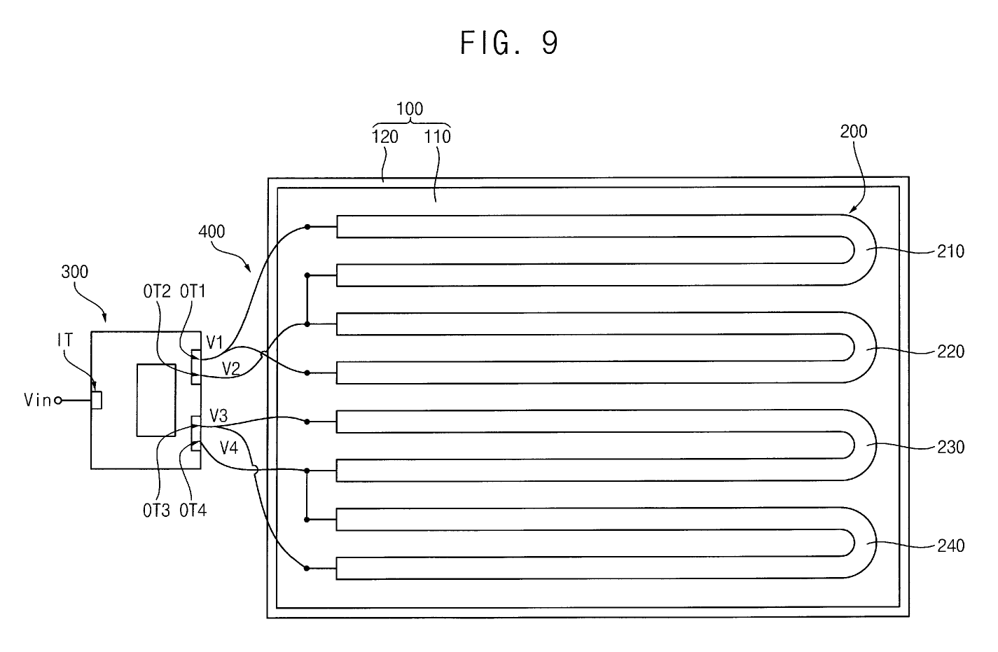

FIG. 9 is a plan view illustrating an exemplary backlight assembly in accordance with exemplary embodiments of the present invention. The backlight assembly illustrated in FIG. 9 has a structure substantially the same as that of the backlight assembly illustrated in FIG. 2 except for an electric connection between the U-shaped lamps 210, 220, 230, 240 and the inverter 300. Thus, any repetitive explanation will be omitted.

Referring to FIGS. 2 and 9, the first electrode of the first U-shaped lamp 210 is electrically connected to the first output terminal OT1 of the inverter 300 by the connection unit 400 to receive the first driving voltage V1 from the first output terminal OT1 of the inverter 300. The second electrode of the first U-shaped lamp 210 is electrically connected to the second output terminal OT2 of the inverter 300 by the connection unit 400 to receive the second driving voltage V2 from the second output terminal OT2 of the inverter 300. The second electrode of the first U-shaped lamp 210 is electrically connected to the first electrode of the second U-shaped lamp 220.

The first electrode of the second U-shaped lamp 220 is electrically connected to the second electrode of the first U-shaped lamp 210 to receive the second driving voltage V2 from the second output terminal OT2 of the inverter 300. The second electrode of the second U-shaped lamp 220 is electrically connected to the first output terminal OT1 of the inverter by the connection unit 400 to receive the first driving voltage V1 from the first output terminal OT1 of the inverter 300.

The first electrode of the third U-shaped lamp 230 is electrically connected to the third output terminal OT3 by the connection unit 400 to receive the third driving voltage V3 from the third output terminal OT3 of the inverter 300. The second electrode of the third U-shaped lamp 230 is electrically connected to the fourth output terminal OT4 of the inverter 300 by the connection unit 400 to receive the fourth driving voltage V4 from the fourth output terminal OT4 of the inverter 300. The second electrode of the third U-shaped lamp 230 is electrically connected to the first electrode of the fourth U-shaped lamp 240.

The first electrode of the fourth U-shaped lamp 240 is electrically connected to the second electrode of the third U-shaped lamp 230 to receive the fourth driving voltage V4 from the fourth output terminal OT4 of the inverter 300. The second electrode of the fourth U-shaped lamp 240 is electrically connected to the third output terminal OT3 of the inverter 300 by the connection unit 400 to receive the third driving voltage V3 from the third output terminal OT3 of the inverter 300.

In the embodiments of the present invention, electric power of the inverter of which one output terminal is electrically connected to two electrodes may be about double as compared to an embodiment in which one output terminal is electrically connected to one electrode.

In embodiments of the present invention, the electrodes of the first, second, third and fourth U-shaped lamps 210, 220, 230, and 240 may be electrically connected to first, second, third, and fourth output terminals OT1, OT2, OT3, and OT4 of the inverter 300 by the driving voltage applying sockets 500 illustrated in FIG. 4.

According to the embodiments of the present invention, because the multi-output transformer 340 outputs the first, second, third, and fourth driving voltages V1, V2, V3, and V4 through the first, second, third, and fourth output terminals OT1, OT2, OT3, and OT4 to drive the first, second, third, and fourth U-shaped lamps 210, 220, 230, and 240, the number of the multi-output transformers employed in the inverter may be decreased so that manufacturing costs may be decreased.

In the above-described embodiments, even though the embodiments of the present invention having the multi-output transformer outputting four driving voltages to the U-shaped lamps has been described, embodiments of the present invention may include a multi-output transformer outputting two driving voltages or more than four driving voltages. For example, the multi-output transformer employed in the embodiments of the present invention may include a two-output transformer, a six-output transformer or an eight-output transformer.

When the multi-output transformer 340 is the two-output transformer, the multi-output transformer 340 may simultaneously drive two U-shaped lamps. When the multi-output transformer 340 is the six-output transformer, the multi-output transformer 340 may simultaneously drive six U-shaped lamps. When the multi-output transformer 340 is the eight-output transformer, the multi-output transformer 340 may simultaneously drive eight U-shaped lamps.

The foregoing is illustrative of the present invention and is not to be construed as limiting thereof Although a few exemplary embodiments of the present invention have been described, those skilled in the art will readily appreciate that many modifications are possible in the embodiments without materially departing from the novel teachings and advantages of this invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A backlight assembly comprising:
a light-generating unit including a first U-shaped lamp and a second U-shaped lamp substantially parallel with each other, electrodes of the first and second U-shaped lamps disposed at one side of the light-generating unit; and
an inverter including a multi-output transformer generating a first driving voltage and a second driving voltage having a phase opposite to a phase of the first driving voltage, and first and second output terminals electrically connecting the first and second U-shaped lamps with the multi-output transformer, the multi-output transformer applying the first and second driving voltages to the first and second U-shaped lamps via the first and second output terminals.

2. The backlight assembly of claim 1, further comprising:
a receiving container including a bottom plate and sidewalls extending from ends of the bottom plate, and receiving the light-generating unit.

3. The backlight assembly of claim 2, wherein one of a first electrode and a second electrode of each of the first and second U-shaped lamps is electrically connected to one of the first and second output terminals to receive one of the first and second driving voltages, and a remainder of the first and second electrodes of each of the first and second U-shaped lamps is electrically connected to the receiving container to receive a ground voltage.

4. The backlight assembly of claim 3, wherein the first electrode and the second electrode of the first U-shaped lamp are electrically connected to the first output terminal and the receiving container to receive the first driving voltage and the ground voltage, respectively,
and the first electrode of the second U-shaped lamp adjacent to the second electrode of the first U-shaped lamp and the second electrode of the second U-shaped lamp are electrically connected to the second electrode of the first U-shaped lamp and the second output terminal to receive the ground voltage and the second driving voltage, respectively.

5. The backlight assembly of claim 3, wherein the first electrode and the second electrode of the first U-shaped lamp are electrically connected to the first output terminal and the receiving container to receive the first driving voltage and the ground voltage, respectively,
and the first electrode of the second U-shaped lamp adjacent to the second electrode of the first U-shaped lamp and the second electrode of the second U-shaped lamp are electrically connected to the second output terminal and the receiving container to receive the second driving voltage and the ground voltage, respectively.

6. The backlight assembly of claim 2, wherein one of a first electrode and a second electrode of each of the first and second U-shaped lamps is electrically connected to one of the first and second output terminals to receive one of the first and second driving voltages, and
a remainder of the first and second electrodes of each of the first and second U-shaped lamps is electrically connected to a remainder of the first and second output terminals to receive a remainder of the first and second driving voltages.

7. The backlight assembly of claim 6, wherein the first electrode and the second electrode of the first U-shaped lamp are electrically connected to the first and second output terminals to receive the first and second driving voltages, respectively,
and the first electrode of the second U-shaped lamp adjacent to the second electrode of the first U-shaped lamp and the second electrode of the second U-shaped lamp are electrically connected to the first and second output terminals to receive the first and second driving voltage, respectively.

8. The backlight assembly of claim 6, wherein the first electrode and the second electrode of the first U-shaped lamp are electrically connected to the first and second output terminals to receive the first and second driving voltages, respectively,
and the first electrode of the second U-shaped lamp adjacent to the second electrode of the first U-shaped lamp and the second electrode of the second U-shaped lamp are electrically connected to the second electrode of the first U-shaped lamp and the first output terminal to receive the second driving voltage and the first driving voltage, respectively.

9. The backlight assembly of claim 2, further comprising:
a connection unit electrically connecting the first and second output terminals with the electrodes of the first and second U-shaped lamps.

10. The backlight assembly of claim 9, wherein the connection unit comprises at least one connector having a first end electrically connected to one of the first and second output terminals and a second end electrically connected to at least two of the electrodes of the first and second U-shaped lamps.

11. The backlight assembly of claim 2, further comprising:
a connection socket received in the receiving container and electrically connected to the electrodes of the first and second U-shaped lamps.

12. The backlight assembly of claim 11, wherein the connection socket comprises driving voltage applying sockets electrically connected to at least one of the electrodes of the first and second U-shaped lamps to apply at least one of the first and second driving voltages to the at least one of the electrodes of the first and second U-shaped lamps.

13. The backlight assembly of claim 12, wherein each of the driving voltage applying sockets passes through a socket through-hole formed in the bottom plate of the receiving container to protrude from a rear surface of the bottom plate, and
a portion of each of the driving voltage applying sockets protruding from the rear surface of the bottom plate has an insertion recess into which the inverter is inserted so that the driving voltage applying sockets are electrically connected to the inverter.

14. The backlight assembly of claim 13, wherein the inverter comprises an inverter substrate on which the multi-output transformer is disposed, and the first and second output terminals comprise metal patterns formed on the inverter substrate to be electrically connected to the driving voltage applying sockets, respectively.

15. The backlight assembly of claim 12, wherein the connection socket further comprises at least one ground voltage applying socket electrically connected to a remainder of the electrodes of the first and second U-shaped lamps, the at least one ground voltage applying socket receiving the ground voltage from the receiving container and applying the ground voltage to the remainder of the electrodes of the first and second U-shaped lamps.

16. The backlight assembly of claim 1, further comprising a third U-shaped lamp and a fourth U-shaped lamp substantially parallel with the first and second U-shaped lamps, electrodes of the third and fourth U-shaped lamps disposed at the one side of the light generating unit; wherein the multi-output transformer generates a third driving voltage and a fourth driving voltage having an opposite phase to that of the third driving voltage, and the inverter includes third and fourth output terminals electrically connecting the third and fourth U-shaped lamps with the multi-output transformer, the multi-output transformer applying the third and fourth driving voltages to the third and fourth U-shaped lamps via the third and fourth output terminals.

17. A backlight assembly comprising:
a light-generating unit including a first U-shaped lamp and a second U-shaped lamp substantially parallel with each other, electrodes of the first and second U-shaped lamps disposed at one side of the light-generating unit; and
an inverter including a multi-output transformer generating a first driving voltage which is applied to the first U-shaped lamp via a first output terminal of the inverter and a second driving voltage which is applied to the second U-shaped lamp via a second output terminal of the inverter.

18. The backlight assembly of claim 17, wherein the second driving voltage has a phase substantially opposite to a phase of the first driving voltage.

19. The backlight assembly of claim 18, further comprising a receiving container including a bottom plate and sidewalls extending from ends of the bottom plate and receiving the light-generating unit,
wherein one of a first electrode and a second electrode of the first U-shaped lamp is electrically connected to the first output terminal to receive the first driving voltage, a remainder of the first and second electrodes of the first U-shaped lamp is electrically connected to the receiving container to receive a ground voltage, one of a first electrode and a second electrode of the second U-shaped lamp is electrically connected to the second output terminal to receive the second driving voltage, and a remainder of the first and second electrodes of the second U-shaped lamp is electrically connected to the receiving container to receive the ground voltage.

20. A display apparatus, comprising:
a backlight assembly generating light, the backlight assembly including:
a light-generating unit including a first U-shaped lamp and a second U-shaped lamp parallel to each other, electrodes of the first and second U-shaped lamps being disposed at one side of the light-generating unit; and
an inverter including a multi-output transformer generating a first driving voltage which is applied to the first U-shaped lamp via a first output terminal of the inverter and a second driving voltage which is applied to the second U-shaped lamp via a second output terminal of the inverter; and
a display panel displaying an image using the light.

21. The display apparatus of claim 20, wherein the second driving voltage has a phase substantially opposite to a phase of the first driving voltage.

22. A method of decreasing manufacturing costs of a backlight assembly, the method comprising:
arranging first and second U-shaped lamps parallel to each other, electrodes of the first and second U-shaped lamps disposed at one side;
electrically connecting an inverter to at least one electrode of each of the first and second U-shaped lamps;
reducing a number of transformers within the backlight assembly by disposing a multi-output transformer on the inverter, the multi-output transformer generating at least a first driving voltage and a second driving voltage;
providing the first driving voltage to the first U-shaped lamp from a first output terminal of the inverter; and,
providing the second driving voltage to the second U-shaped lamp from a second output terminal of the inverter.
